(19) United States
(12) Patent Application Publication
(10) Pub. No.: US 2025/0000157 A1
(43) Pub. Date: Jan. 2, 2025

(54) Heating Transfer Device With Integrated Temperature Sensor

(71) Applicant: Shenzhen Yocan Technology Co., Ltd., Shenzhen (CN)

(72) Inventors: Roger Romero, Stockton, CA (US); Zhiling Zhang, Shenzhen (CN)

(21) Appl. No.: 18/437,233

(22) Filed: Feb. 8, 2024

(30) Foreign Application Priority Data
Jun. 27, 2023 (CN) 202321668072.4

(51) Int. Cl. A24F 40/51; A24F 1/30; A24F 40/46; A24F 40/60; A24F 40/70; A24F 40/90; H05B 3/42

(52) U.S. Cl. CPC A24F 40/51; A24F 1/30; A24F 40/46; A24F 40/60; A24F 40/70; A24F 40/90; H05B 3/42

(57) ABSTRACT

An apparatus includes a heating element and a temperature sensor both integrated within an enclosure. The heating element is disposed at one end of the enclosure and the temperature sensor is disposed at an opposite end of the enclosure. The enclosure has an enclosure length (EL) and the heating element has a heating element length (HEL), a heating element width (HEW), and a heating element thickness (HET). In one example, the enclosure is long and tubular, and the heating element is flat and rectangular with dimensions that promote portability and ease of use (for example, HEL<EL/3, HEW<HEL/2, and HET<HEW/5). During operation, the temperature sensor detects when a surface reaches a desired temperature. The heating element is activated and is used to partially heat and transfer material to the surface. The heating element causes the material to become more malleable for transport without vaporizing material.

### TECHNICAL FIELD

The present invention relates to smoking instruments, and more specifically to the operation of smoking devices.

### BACKGROUND INFORMATION

A water pipe is a common tool used to smoke and inhale smoking material. A typical water pipe includes a mouthpiece, one or more chambers, a downstem, and a dish. The dish is heated with a butane torch or other heating mechanism. Smoking material, such as a concentrate or extract, is placed on the dish. The dish is heated thereby causing the smoking material to evaporate. The vapor or smoke generated from heating the smoking material passes through the downstem and chamber(s) and is inhaled by the user via the mouthpiece of the water pipe.

### SUMMARY

An apparatus includes an enclosure, a heating element, and a temperature sensor. The heating element and the temperature sensor are both integrated within the enclosure. The heating element is disposed at one end of the enclosure and the temperature sensor is disposed at an opposite end of the enclosure. The enclosure has an enclosure length (EL) and the heating element has a heating element length (HEL), a heating element width (HEW), and a heating element thickness (HET). In one embodiment, the enclosure is long and tubular, and the heating element is flat and rectangular with dimensions that promote portability and ease of use. For example, the heating element length is less than a third of the enclosure length (HEL<EL/3), the heating element width is less than half of the heating element length (HEW<HEL/2), and the heating element thickness is less than a fifth of the heating element width (HET<HEW/5).

During operation, a user heats a surface using a separate heating source such as a torch. The user uses the integrated temperature sensor to detect when a temperature of the surface has reached a desired temperature. Next, the user heats the heating element and applies the heating element to material to be transferred. This causes the material to become more malleable and/or partially separate. Next, the user uses the heating element to lift the material and transfer the material to the surface.

Further details, embodiments, and methods are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a side view cross section diagram of a heat transfer device with integrated temperature sensor 10.

FIG. 2 is another side view cross section diagram of the heat transfer device with integrated temperature sensor 10.

FIG. 3 is a front view of the heat transfer device with integrated temperature sensor 10.

FIG. 4 is a side view of the heat transfer device with integrated temperature sensor 10 showing the main housing 47 connected to housing bottom 49 of enclosure 50.

FIG. 5 is a back view of the heat transfer device with integrated temperature sensor 10 showing the charging port 28 disposed within the main housing bottom 49 of enclosure 50.

FIG. 6 is a perspective view of the heat transfer device with integrated temperature sensor 10 showing temperature sensor 40 disposed within the second end 52 of enclosure 50.

FIG. 7 is a top view of the heat transfer device with integrated temperature sensor 10.

FIG. 8 is a bottom view of the heat transfer device with integrated temperature sensor 10.

FIG. 9 shows the heat transfer device with integrated temperature sensor 10 with heating container 73.

FIG. 10 shows the heat transfer device with integrated temperature sensor 10 with storage container 102.

FIG. 11 shows the heat transfer device with integrated temperature sensor 10 with heating container 73.

FIG. 12 an exploded perspective view of the heat transfer device with integrated temperature sensor 10.

FIG. 13 an exploded perspective view of the heat transfer device with integrated temperature sensor 10.

FIG. 14 is a flowchart of method 100.

FIG. 15 is a flowchart of method 200.

### DETAILED DESCRIPTION

Reference will now be made in detail to some embodiments of the invention, examples of which are illustrated in the accompanying drawings.

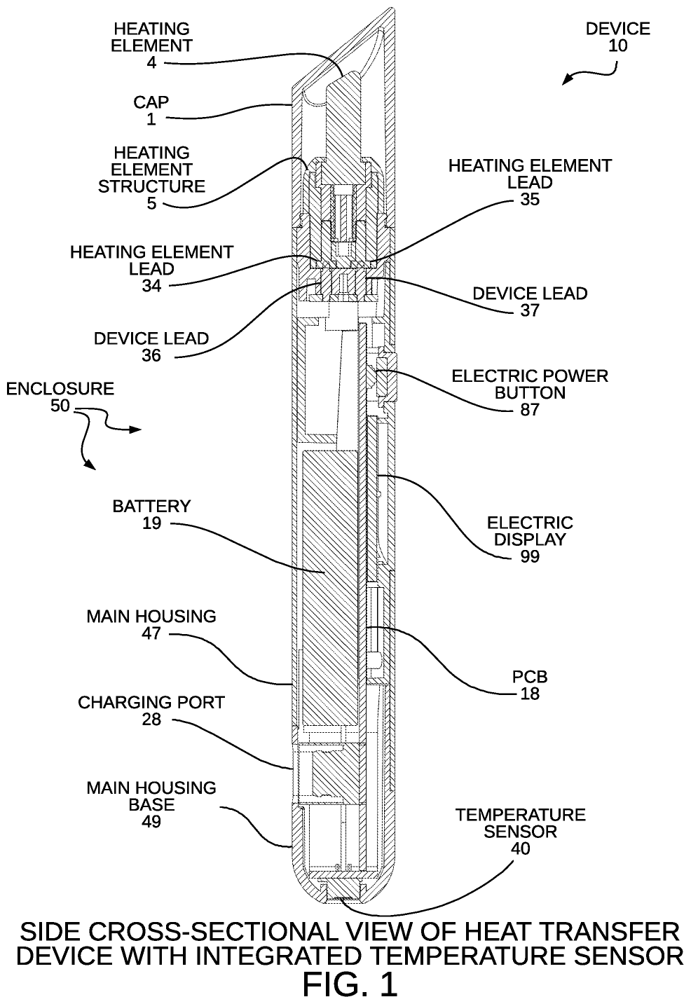

FIG. 1 is a side view cross section diagram of a heat transfer device with integrated temperature sensor 10. Device 10 includes an enclosure 50, heating element 4, and temperature sensor 40. Enclosure 50 has a first end 51 opposite a second end 52. Enclosure 50 includes main housing 47 and main housing bottom 49. Heating element 4 is disposed at the first end 51 of enclosure 50. Temperature sensor 40 is disposed at the second end 52 of enclosure 50.

FIG. 1 shows the heating element 4 is partially disposed within a heating element structure 5. Heating element structure 5 includes heating element leads 34-35 and device leads 36-37. The heating element leads 34-35 are coupled to heating element 4. Heating element structure 5 is detachably coupled to the first end 51 of enclosure 50.

FIG. 1 shows device 10 including a cap 1 that is attached to the first end 51 of enclosure 50. The cap 1 is used to cover heating element 4 and can be removed. As explained below, the cap 1 includes cap fitting attributes 6 and 7 that are designed to receive enclosure fitting attributes 8 and 9 of the enclosure 50. By attaching the cap 1 to enclosure 50, the cap 1 is secure and does not move until detached.

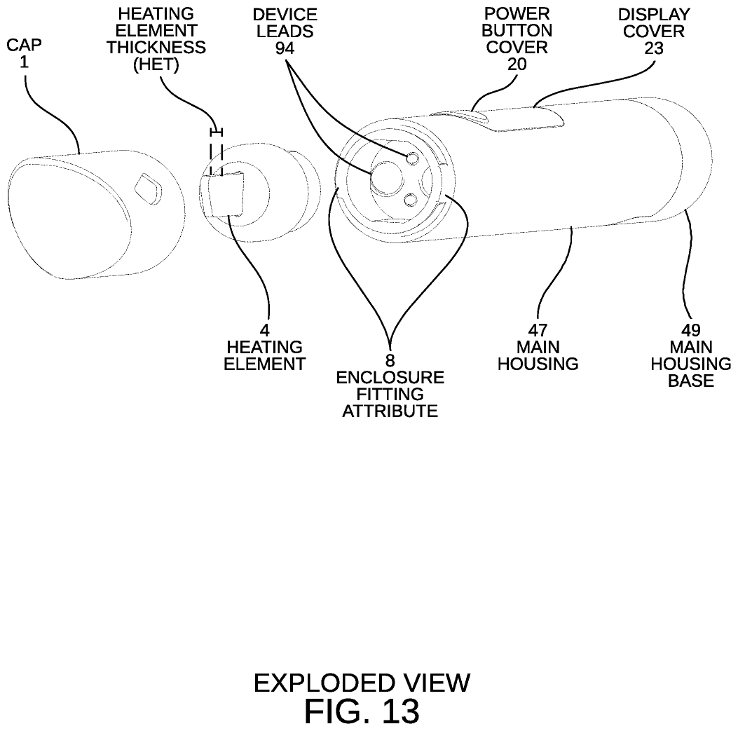

The device 10 of FIG. 1 includes battery 19 which is coupled to a printed circuit board (PCB) 18, an electronic display 99, temperature sensor 40, heating element 4, charging port 28, and an electric power button 87. The PCB 18, electronic display 99, temperature sensor 40, charging port 28, and an electric power button 87 are each at least partially enclosed by enclosure 50. For example, battery 19 is coupled when device leads 94 (see FIG. 13) are coupled to heating element leads 34 of heating element 4.

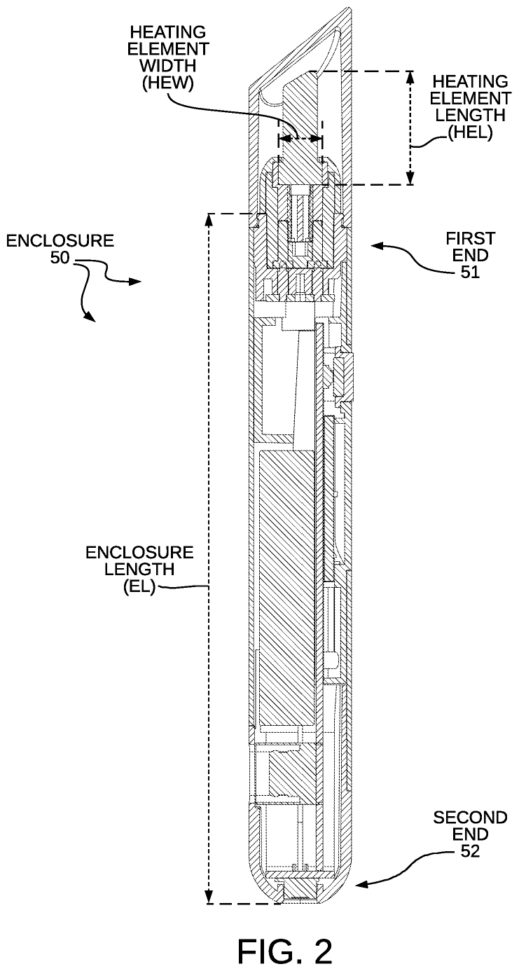

FIG. 2 is a side view cross section diagram of the heat transfer device with integrated temperature sensor 10. FIG. 2 shows the enclosure 50 having an enclosure length (EL), heating element 4 having a heating element length (HEL) and a heating element width (HEW). Heating element 4 has a heating element thickness (HET) as shown in FIG. 13. In one example, the heating element length (HEL) of heating element 4 is less than a third of the enclosure length (EL) of enclosure 50, the heating element width (HEW) of heating element 4 is less than half of the heating element length (HEL) heating element 4, and the heating element thickness (HET) of heating element 4 is less than a fifth of the heating element width (HEW) of heating element 4.

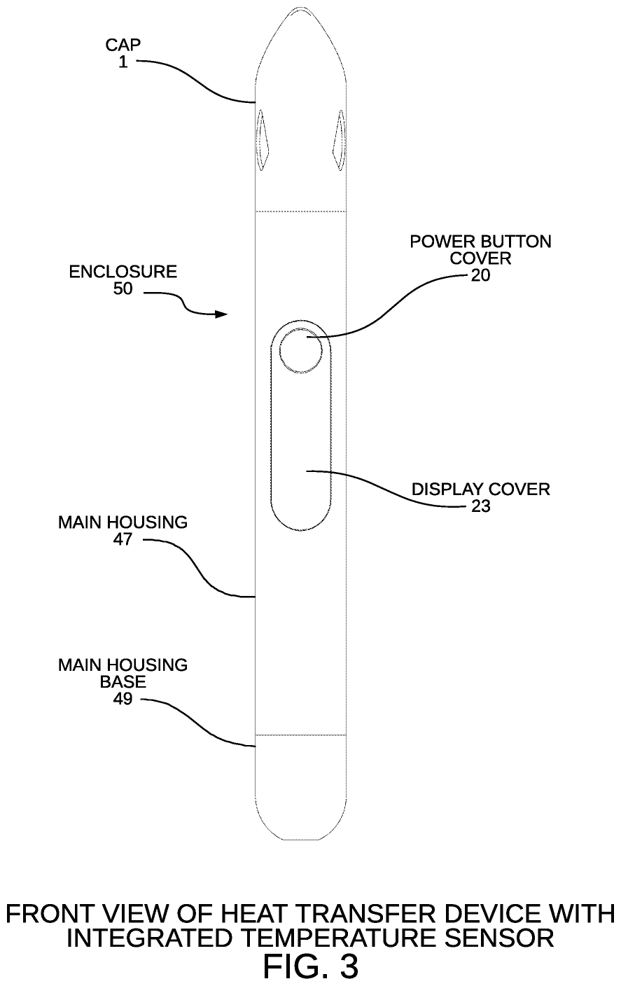

FIG. 3 is a front view of the heat transfer device with integrated temperature sensor 10. FIG. 3 shows device 10 including a power button cover 20 and a display cover 23. Display cover 23 comprises a see-through material that covers and protects electric display 99. In the example shown in FIG. 3, power button cover 20 is a button that is used to activate electric power button 87 and is disposed within an opening of display cover 23. In another embodiment, power button cover 20 is a switch that replaces electric power button 87.

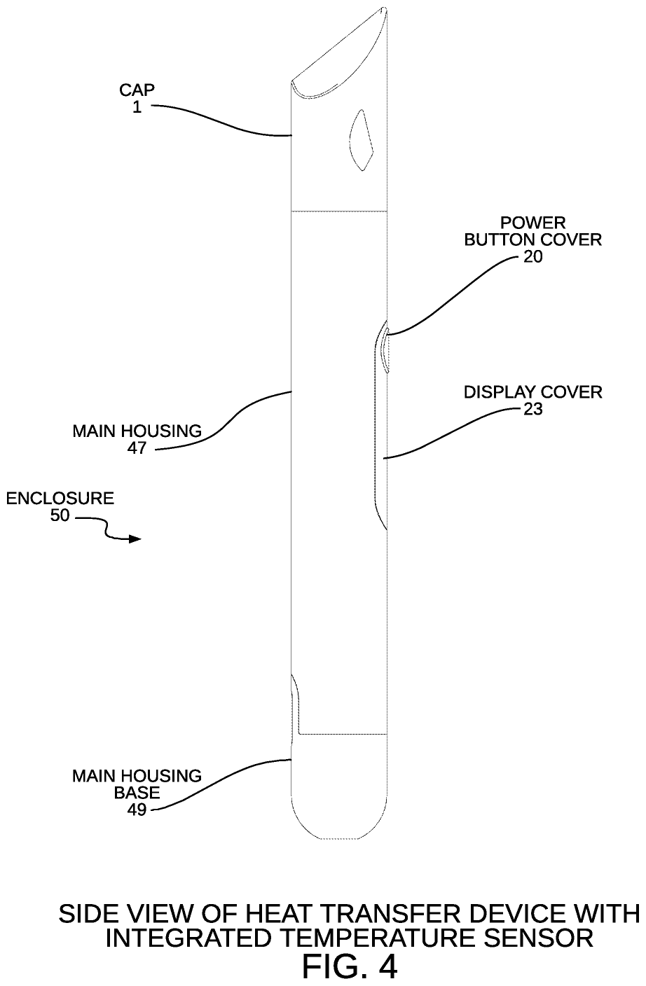

FIG. 4 is a side view of the heat transfer device with integrated temperature sensor 10 showing the main housing 47 connected to housing bottom 49 of enclosure 50. In the example of FIG. 4, power button cover 20 protrudes beyond the display cover 23 and main housing 47. Although not shown, when power button cover 20 is pressed, the power button cover 20 slightly recedes within the main housing 47.

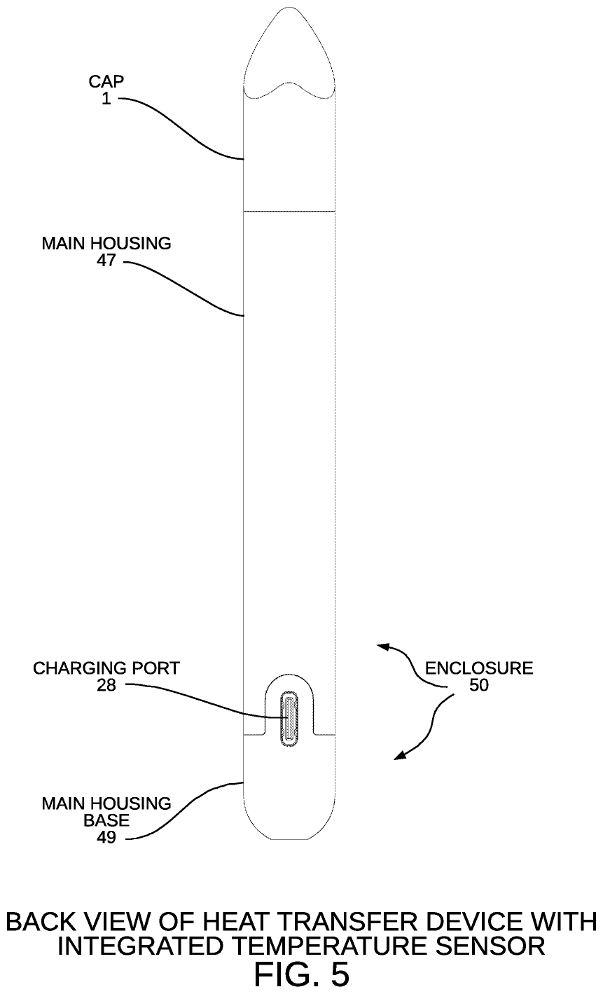

FIG. 5 is a back view of the heat transfer device with integrated temperature sensor 10 showing the charging port 28 disposed within the main housing bottom 49 of enclosure 50. Charging port 28 is used to charge the battery 19.

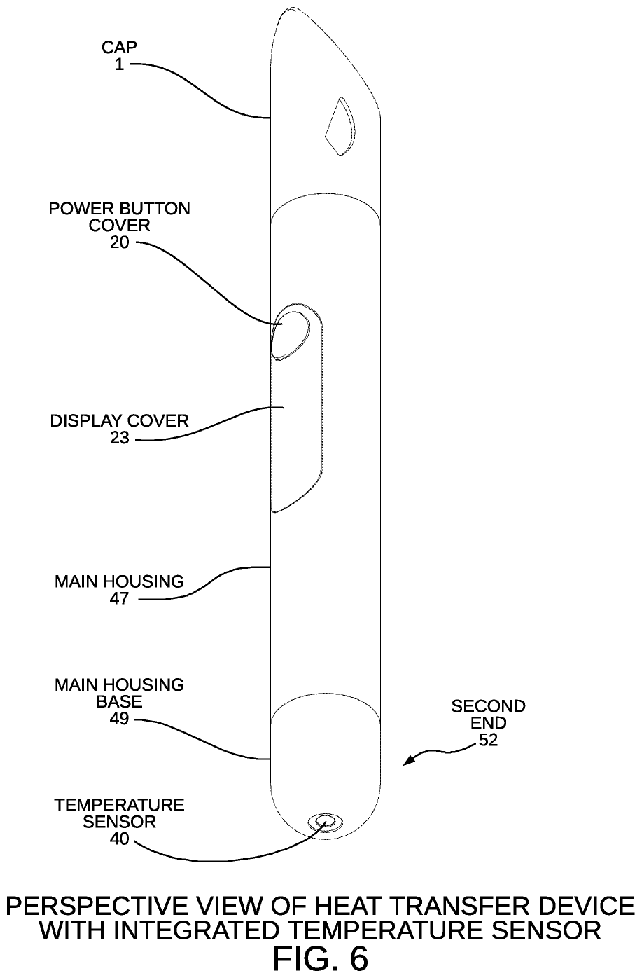

FIG. 6 is a perspective view of the heat transfer device with integrated temperature sensor 10 showing temperature sensor 40 disposed within the second end 52 of enclosure 50. FIG. 6 shows the temperature sensor 40 partially surrounded by the main housing bottom 49. The main housing bottom 49 of enclosure 50 protects the temperature sensor 40, while still allowing temperature sensor 40 to detect temperature.

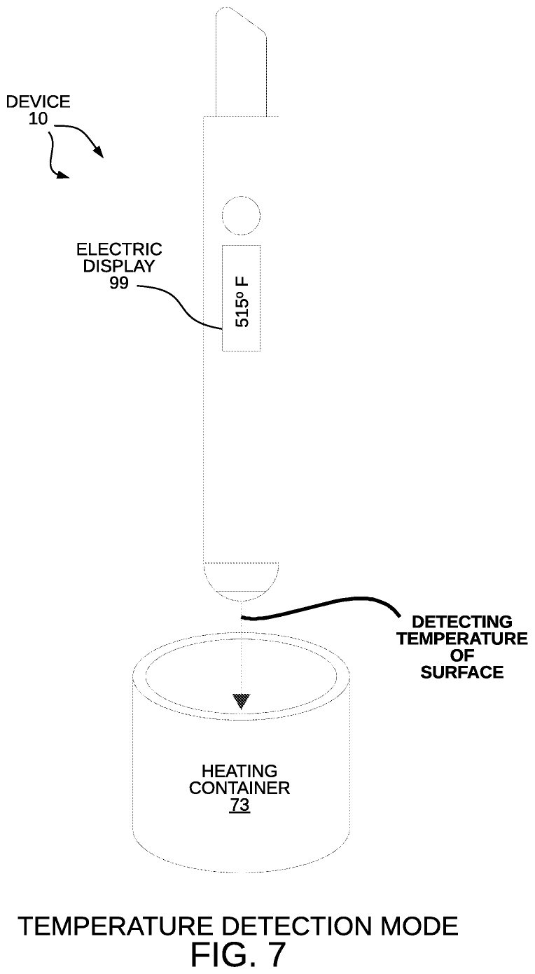

FIG. 7 is a top view of the heat transfer device with integrated temperature sensor 10.

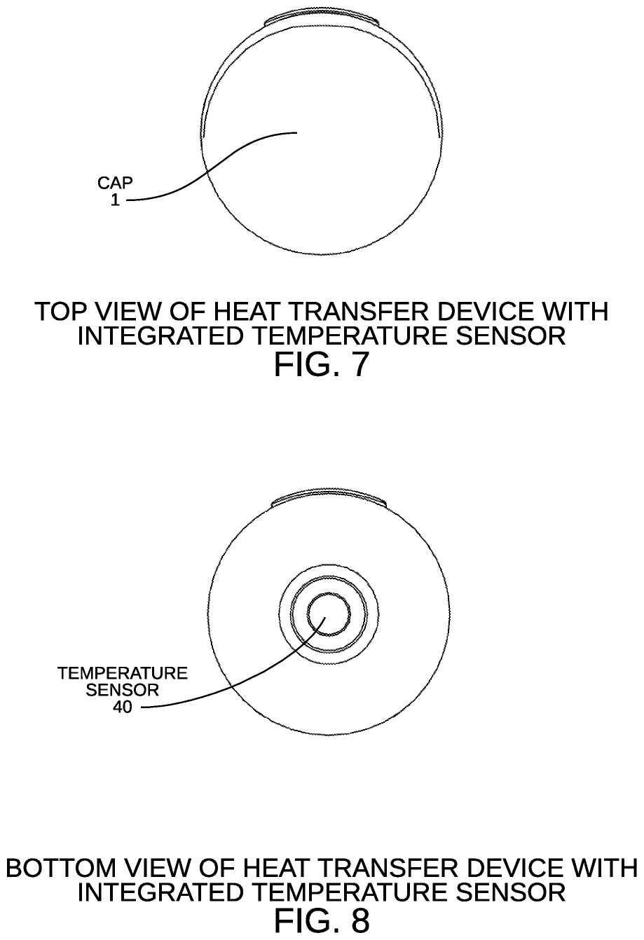

FIG. 8 is a bottom view of the heat transfer device with integrated temperature sensor 10.

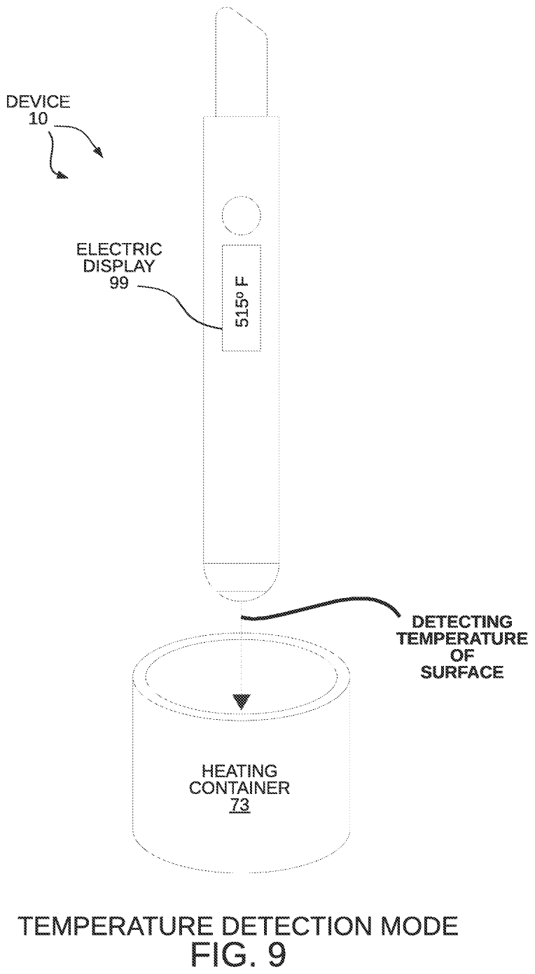

FIG. 9 shows the heat transfer device with integrated temperature sensor 10 with heating container 73. In the example shown in FIG. 9, temperature sensor 40 is detecting the temperature of heating container 73.

The heat transfer device with integrated temperature sensor 10 is operable in at least two modes: a temperature detection mode and a heating mode. In the temperature detection mode, the temperature sensor 40 detects the temperature of a surface that the temperature sensor 40 is directed towards.

To activate temperature detection mode, a user holds enclosure 50 and aims the temperature sensor 40 at a surface. In one example, the user presses the power button cover 20, which depresses the electric power button 87. When depressed electric power button 87 activates battery 19. Battery 19 is coupled to the temperature sensor 40 and PCB 18. In the temperature detection mode, PCB 18 sends an electrical signal to activate the temperature sensor 40. In the temperature detection mode, electric display 99 displays a reading of the detected temperature of the surface.

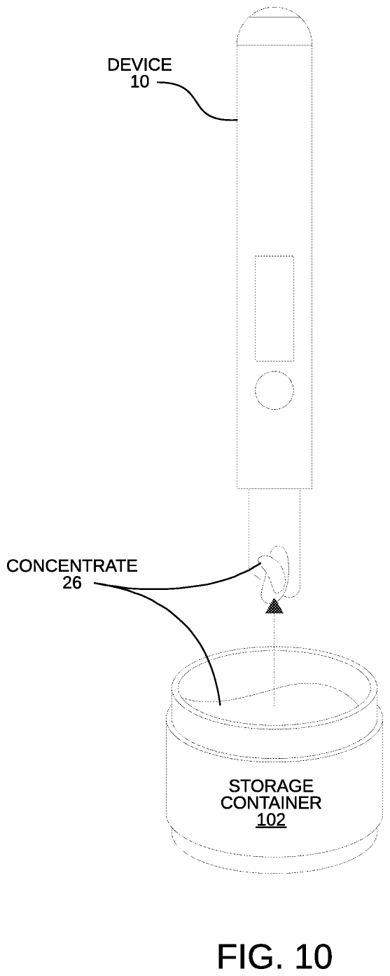

FIG. 10 shows the heat transfer device with integrated temperature sensor 10 with storage container 102. FIG. 10 shows storage container 102 containing an amount of solid concentrate 26. The user places a portion of the heating element 4 into the storage container 102 to retrieve a desired amount of solid concentrate 26. During this stage, it is not necessary that the heating element 4 is heated nor is it necessary that the temperature sensor 40 be active.

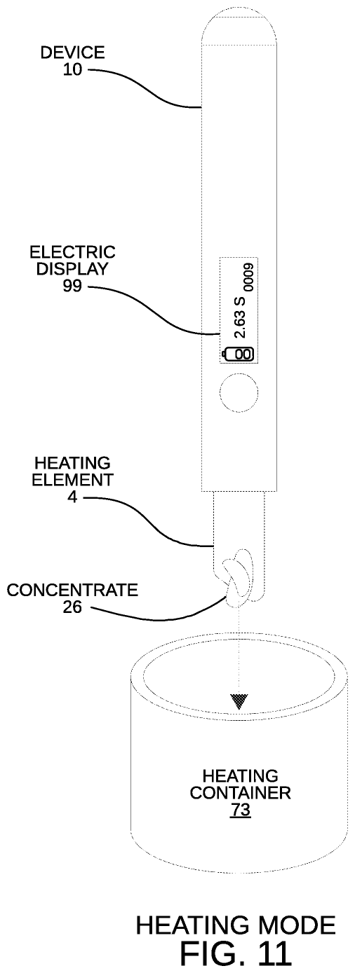

FIG. 11 shows the heat transfer device with integrated temperature sensor 10 with heating container 73. In the example shown in FIG. 11, heating element 4 is being heated. FIG. 11 shows electronic display 99 showing the battery life (about 66%), time elapsed from activating heating mode for heating element 4 (2.63 seconds), and the number of times the heating element 4 has been activated (9) in heating mode.

In the heating mode, heating element 4 is heated.

To activate heating mode, a user holds enclosure 50 and aims the heating element 4 above a surface. In one example, the user presses the power button cover 20, which depresses the electric power button 87. When depressed a predetermined amount of times, electric power button 87 activates battery 19 and sends a signal to PCB 18. In the heating mode, PCB 18 sends an electrical signal to heat element 4. When the electric power button 87 is depressed again, the heating mode deactivates. While in the heating mode, electric display 99 displays battery life, the amount of time elapsed during heating mode (timer), and the number of times heating mode has been activated. By heating the heating element 4, the concentrate 26 liquifies and drops into heating container 73.

In one embodiment, heating mode is not activated while device 10 is in temperature detection mode. In one embodiment, heating mode cannot be activated while cap 1 is coupled to enclosure 50 because of the addition of a sensor that detects cap 1.

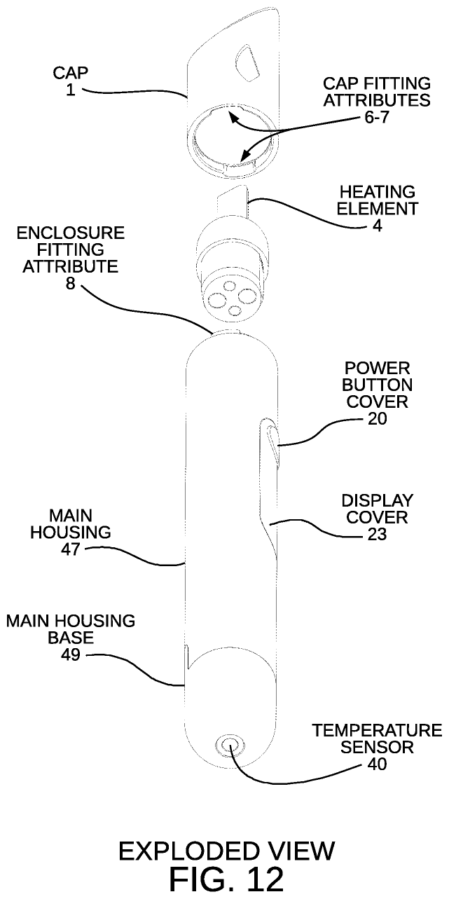

FIG. 12 an exploded perspective view of the heat transfer device with integrated temperature sensor 10. FIG. 12 shows one example of cap fitting attributes 6 and 7 of cap 1 that are designed to receive the enclosure fitting attributes 8 and 9 of the enclosure 50.

FIG. 13 an exploded perspective view of the heat transfer device with integrated temperature sensor 10. FIG. 13 shows heating element thickness (HET) as well as device leads 94-97. FIG. 13 shows the heating element 4 being detached from the enclosure 50 of device 10.

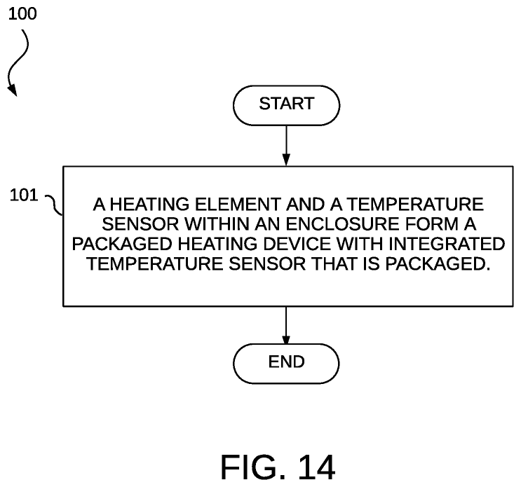

FIG. 14 is a flowchart of method 100. In a first step (step 101), a heating element and a temperature sensor within an enclosure form a packaged heating device with integrated temperature sensor that is packaged.

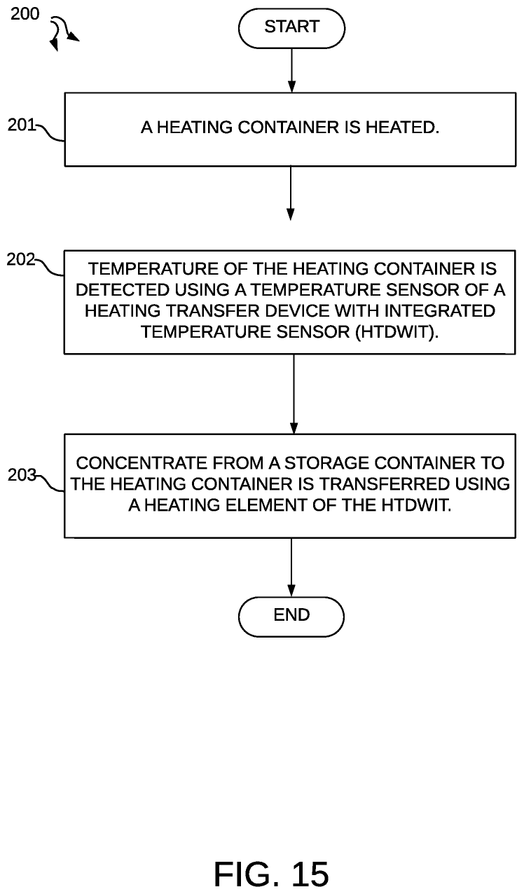

FIG. 15 is a flowchart of method 200. In a first step (step 201), a heating container is heated. In a second step (step 202), a temperature of the heating container has reached a target temperature level using a temperature sensor of a Heating Transfer Device With Integrated Temperature Sensor (HTDWIT) is detected. In a third step (step 203) concentrate from a storage container to the heating container is transferred using a heating element of the HTDWIT. For additional information on the structure and function of the heat transfer device with integrated temperature sensor 10, including how to manufacture and operate, see Chinese Publication CN220146003U, the entire subject matter of the foregoing document which is hereby incorporated by reference.

Although certain specific embodiments are described above for instructional purposes, the teachings of this patent document have general applicability and are not limited to the specific embodiments described above. In other examples, the temperature detection and heating modes may be activated by various means. For example, holding or double tapping the electric power button 87 may activate various automated or pre-determined settings that were previously set by the user. Additionally, other additions such as sounds or haptics when a specific temperature is detected may be added in addition to the displayed temperature. Additionally, in this example, the temperature sensor 40 can detect and electronic display 99 can display temperatures up to 999 degrees fahrenheit. In another example the electronic display 99 can display mass of solid concentrate disposed on the heating element 4. Also, electronic display 99 can feature LEDs or other lights that represent various modes (e.g. on/off, temperature detection mode/heating mode). Furthermore, in one embodiment device 10 includes an antenna which is coupled to PCB 18 that can communicate to other devices wirelessly (e.g. mobile device). Accordingly, various modifications, adaptations, and combinations of various features of the described embodiments can be practiced without departing from the scope of the invention as set forth in the claims.

1. An apparatus comprising:
an enclosure;
a heating element; and
a temperature sensor, wherein the heating element and the temperature sensor are integrated within the enclosure.

2. The apparatus of claim 1, wherein the heating element is disposed at a first end of the enclosure, wherein the temperature sensor is disposed at a second end of the enclosure, and wherein the first end is opposite the second end.

3. The apparatus of claim 1, wherein the enclosure has an enclosure length (EL), wherein the heating element has a heating element length (HEL), and wherein the heating element length (HEL) is less than a third of the enclosure length (EL).

4. The apparatus of claim 3, wherein the heating element has a heating element width (HEW), and wherein the heating element width (HEW) is less than half of the heating element length (HEL).

5. The apparatus of claim 4, wherein the heating element has a heating element thickness (HET), and wherein the heating element thickness (HET) is less than a fifth of the heating element width (HEW).

6. The apparatus of claim 1, further comprising:
a cap, wherein the cap removably attaches to the enclosure thereby covering the heating element.

7. The apparatus of claim 1, further comprising:
a switch; and
a battery, wherein when the switch is enabled, the battery is discharged thereby heating the heating element.

8. The apparatus of claim 7, wherein the switch is a single button that selectively engages a temperature sensing mode and a heating mode, wherein the apparatus further comprises:
a charging port, wherein the charging port is used to charge the battery.

9. The apparatus of claim 1, further comprising:
a temperature indicator, wherein the temperature indicator outputs a temperature detected by the temperature sensor.

10. The apparatus of claim 1, further comprising:
a timer, wherein the timer indicates a length of time the heating element is activated.

11. A method comprising:
packaging a heating element and a temperature sensor within an enclosure thereby forming a packaged heating device with integrated temperature sensor.

12. The method of claim 11, wherein the heating element is packaged along a first end of the enclosure, wherein the temperature sensor is packaged along on a second end of the enclosure, and wherein the first end is opposite the second end.

13. The method of claim 11, wherein the enclosure has an enclosure length (EL), wherein the heating element has a heating element length (HEL), and wherein the heating element length (HEL) is less than a third of the enclosure length (EL).

14. The method of claim 13, wherein the heating element has a heating element width (HEW), and wherein the heating element width (HEW) is less than half of the heating element length (HEL).

15. The method of claim 14, wherein the heating element has a heating element thickness (HET), and wherein the heating element thickness (HET) is less than a fifth of the heating element width (HEW).

16. The method of claim 11, further comprising:
attaching a cap onto the enclosure thereby covering the heating element.

17. The method of claim 11, further comprising:
providing the packaged heating device with integrated temperature sensor to a user, wherein the user uses the packaged heating device with integrated temperature sensor to detect a temperature of a heating container and to transfer concentrate from a storage container to the heating container.

18. The method of claim 11, further comprising:
attaching a switch to the enclosure; and
packaging a battery within the enclosure, wherein when the switch is enabled, the battery is discharged thereby heating the heating element.

19. A packaged heating device with integrated temperature sensor comprising:
an enclosure; and
means for heating and detecting temperature, wherein the means is integrated within the enclosure.

20. The packaged heating device with integrated temperature sensor of claim 19, wherein the means comprises a hot knife and a temperature sensor.

21. (canceled)
